(19) United States
(12) Patent Application Publication
(10) Pub. No.: US 2018/0338666 A1
(43) Pub. Date: Nov. 29, 2018

(54) DISHWASHER SYSTEM

(71) Applicant: Jet Aviation AG, Basel (CH)

(72) Inventors: Peter Seewang, Vöhrenbach (DE); Matthias Mueller, Wahlbach (FR)

(73) Assignee: Jet Aviation AG, Basel (CH)

(21) Appl. No.: 15/757,919

(22) PCT Filed: Sep. 8, 2016
(86) PCT No.: PCT/EP2016/071187

§ 371 Date: Mar. 6, 2018

(30) Foreign Application Priority Data
Sep. 8, 2015 (CH) 01294/15

(51) Int. Cl. A47L 15/00; A47L 15/46; A47L 15/42; A47L 15/50; B60R 15/02

(52) U.S. Cl. CPC A47L 15/0089; A47L 15/46; A47L 15/4223; A47L 15/427; A47L 15/4285; A47L 15/4291; B60R 15/02; A47L 15/4268; A47L 15/4293; A47L 15/50; A47L 15/4209; A47L 15/4257; A47L 15/4253

(57) ABSTRACT

A dishwasher system which comprises a washing unit. The washing unit comprises an outer housing and an inner housing enclosing a washing chamber and a door for closing a front opening of the washing chamber. The washing system also comprises a control unit for controlling the dishwashing operation.

### FIELD OF THE INVENTION

The present invention is directed to a dishwasher suited to be used in an aircraft or a similar vehicle.

### BACKGROUND OF THE INVENTION

DE19708805 A1 was published on 30 Apr. 1997 on behalf of Winterhalter Gastronom GmbH and discloses a dishwasher to be used in air, land and water vehicles. The document discloses a relatively big dishwasher device which comprises a rack for receiving goods to be cleaned. The dishwasher further comprises cleaning nozzles which are arranged under the rack and directed to the rack, when the rack is mounted inside of the dishwasher. Therefore, the disclosed dishwasher comprises a tilted guidance for the rack, such that in a mounted state, the rack is in a tilted position with respect to a horizontal plane of the vehicle. Thus, a safe positioning of the goods to be cleaned as well as the rack should be obtained, in order to operate the dishwasher also in moving vehicles. Due to the tilted alignment of the rack, the dishwasher has a relatively bulky design. Thus, the installation space required for installing it in a vehicle is relatively big. Consequently, such types of the dishwasher can only be installed in relatively big vehiIles and furthermore may require major modifications of the vehicle prior to installation.

U.S. Pat. No. 6,055,996 was published on 2 May 2000 on behalf of DaimlerChrysler Aerospace Airbus GmbH and describes an apparatus for washing dishes and cutlery especially in a food service system in an aircraft. The document discloses an apparatus which includes a service trolley and a washing unit that can be coupled together to form a washing chamber within the trolley. According to U.S. Pat. No. 6,055,996, the washing unit of the apparatus is installed within a trolley parking bay in a galley of the aircraft and is connected to a water supply and a power supply. The trolley is equipped with racks for receiving the dirty utensils, and the washing unit is equipped with water spray arms that reach into the trolley into clearance spaces between the racks. The dirty utensils are collected from passengers directly into the service trolley, which is then wheeled into position in the trolley parking bay, and coupled to the washing unit.

### SUMMARY OF THE INVENTION

Conventional dishwashers (such as domestic dishwashers) have several characteristics which result in major drawbacks when being used in vehicles. Within the context of the present invention, vehicles include air vehicles (in particular aircraft), land vehicles (in particular rail and road vehicles, such as trains, buses or recreational vehicles) as well as water vehicles, such as watercraft. However, in order to provide a concise description of the invention, it will be described mainly for use in aircraft, although not limited to such types of vehicles.

A major problem known from conventional dishwashers used in most types of aircraft is that they are relatively big and heavy. Another problem is related to the fact that they typically comprise an open tank where the washing fluid (e.g. water with detergent) is collected and temporarily stored during a washing cycle. As movements of an aircraft typically cause changing accelerations (in horizontal as well as vertical direction) acting on the content of the tank, the washing fluid may slosh.

Therefore, appropriate means are needed in order to prevent wash fluid from swashing out of a dishwasher's housing as well as from swashing in general, as swashing may deteriorate washing results and/or lead to damage of the dishwasher and/or the interior fitting, affecting cabin safety.

Another problem known from conventional dishwashers is that when opening the door of the dishwasher after a washing cycle has finished typically warm and humid air escapes from inside of the washing chamber. On the one hand this may be uncomfortable or even dangerous for a user. On the other hand such escaping wet air may cause condensation of water on the front surfaces of the surrounding galley and/or the dishwasher's outer surfaces. Such condensation effects may cause staining of the front surfaces of the interior fittings, which for several reasons is highly undesirable.

As well, maintenance and repair of conventional dishwashers installed in aircraft is time- and labor-consuming, as they are usually thoroughly fastened to the surrounding interior fittings, which makes dismounting and disassembly of a dishwasher complicated. As well, some aircraft (e.g. VIP aircraft) may comprise interior fittings and floors made from exquisite materials which also extend to the galley. In order to prevent pollution or even damage of these materials, the amount of maintenance of the dishwasher which has to be performed in the passenger compartment should be as low as possible.

Another problem known from conventional dishwashers as used in aircraft is that dishes and/or cutlery have to be removed from the washing chamber as soon as periods of high acceleration are expected. The same holds true for the racks (baskets, trays) used in traditional dishwashers which are not suited for being used when turbulence is expected. This particularly holds true for dishwashers used in aircraft, where the items to be cleaned and/or even the racks have to be removed from the washing chamber during taxi, takeoff, landing or due to air turbulences.

In order to solve at least one of the aforementioned problems, a dishwasher system according to the present invention typically comprises a washing unit with an outer housing and an inner housing enclosing a washing chamber. Furthermore it typically comprises a door for closing a front opening of the washing chamber, as well as a controt unit for controlling the dishwashing operation. An inner housing may also be partially delimitated by the outer housing, as will be described in further detail below. The door may also be the door of a drawer-type washing unit.

Depending on the field of application, the outer housing may be made from a lighter and/or stiffer material than the inner housing. Good results may be obtained if the outer housing is made from a material which has a lower specific weight than the inner housing. The inner housing may e.g. be made from a material that is chemically resistant to dishwashing detergents such as a stainless steel and/or a titanium (respectively titanium alloy), whereas the outer housing may be made from an aluminum and/or a plastic and/or a fiber reinforced plastic, such as a plastic reinforced by carbon fibers and/or aramid fibers and/or glass fibers. A particularly lightweight outer housing may be obtained if the outer housing comprises a composite material. The inner housing and/or the outer housing may be made from multiple materials. For example some parts of the outer housing may be made from a carbon fiber reinforced plastic, whereas some other parts may be made from an aluminum alloy. Alternatively or in addition, further parts of the washing unit may be made from material which has a lower specific weight than the inner housing, such as e.g. a support structure for the inner housing and/or the outer housing. Hence, a dishwasher may comprise a structural framework made from e.g. a carbon fiber reinforced plastic to which the inner housing and the outer housing are fastened.

In order to reduce weight of the dishwasher system, the dishwasher system may comprise at least one fluid line comprising tubes made at least partially from fiber reinforced plastics, such as carbon fiber reinforced plastics. Thus, compared to using relatively thick and thus heavy conventional tubes and/or hoses—which may even be armored—the weight of the fluid lines can significantly be reduced. In order to obtain good fire resistance, fiber reinforced plastics comprising good fire resistance may be used. For example carbon fiber reinforced plastics comprising flame retardant epoxy resins may be applied. In contrast to conventional hoses and tubes, such types of fluid lines do not have to be encased in heavy in complex fire containments in order to meet fire protection standards for aircraft such as e.g. defined by U.S. Federal Aviation Regulations. Other types of fibers as well of combinations of multiple different types of fibers may be used, comprising fibers made from glass, aramid, ceramic, basalt and others. As well, instead of an epoxy resin, other types of resins may be used, including thermosetting plastics—such as e.g. PEEK.

Convenient access to the washing chamber as well as good draining may be obtained if the inner housing is arranged at least partially in the upper half of the outer housing with respect to vertical direction. A dishwasher system which is particularly safe when used in a vehicle may be obtained if it comprises a drip pan which is arranged below the inner housing. Due to the presence of such a drip pan, liquids leaking from the inner housing can be collected and prevented from leaking from the outer housing which else may interfere with user safety, in particular with cabin safety when used in an aircraft. Good leakage prevention may be obtained if a drip pan is arranged also below other components of the washing unit which comprise fluids, such as e.g. below a water pump and/or a reservoir for water and/or fluid connectors. A drip pan may also be a portion of the outer housing. If required a sensor is present indicating presence of a liquid in the drip pan. Alternatively of in addition one or multiple liquid contact indicators may be arranged in the dip pan and/or other places inside of the dishwasher's outer housing. Good results may be obtained using liquid contact indicator stickers. The total weight of a dishwasher system may be significantly decreased if the drip pan is made from a fiber reinforced plastic, such as a carbon fiber reinforced plastic.

In order to obtain good draining, in particular complete emptying of the washing chamber, the inner housing may comprise a floor pan with a drainage arranged at the lowest point of the floor pan. Thus virtually all liquids may be easily removed from the washing chamber, which is important for some applications, as subsequently described.

Depending on the field of application an exhaust valve is present to seal the drainage. Thus, the drainage may be opened and/or closed actively, in contrast to conventional dishwasher systems which usually comprise traps (siphons), where typically a minimum amount of grey water will remain after a washing cycle. Thus, such a variation of a dishwasher system will e.g. allow a fast and complete draining of the dishwasher system in order to prevent ice related damage when stored at very low temperatures, which may be the case for vehicles in wintertime.

Alternatively or in addition, the washing unit may comprise a docking panel arranged at the outer housing. A dishwasher system may comprise multiple docking panels. Complete draining (depletion) of a washing unit may be easily obtained if the drainage and the docking panel are interconnected to each other by at least one continuously (downward) sloping fluid line. A downward sloping fluid line may comprise a tube and/or a hose. Alternatively or in addition, the washing unit may be arranged to be drained by means of compressed air. Therefore, the washing unit may e.g. comprise means to be connected to the bleed air system of an aircraft.

For some applications an exhaust pump (drain pump) may be present to exhaust (drain) the washing chamber of the dishwasher assembly actively. Such an exhaust pump may be arranged inside or outside of the outer housing and is normally functionally interconnected to the exhaust valve. A dishwasher system that can be installed and removed in a particularly easy manner may be obtained if the docking panel comprises at least one quick coupling arranged to interconnect to a counterpart (quick release connectors). Such a quick coupling may e.g. be an electrical quick coupling and/or a fluidic quick coupling. Quick couplings may e.g. have a quarter-turn design.

Safety of use of the dishwasher system may be increased if the washing unit comprises a first valve arranged at the fresh water inlet and a second valve arranged at the grey water outlet, in case of no electrical power being provided to the washing unit the first valve being configured such that when the fresh water inlet is connected to a fresh water supplying line, the valve closes (cuts influx), and the second valve being configured such that when the grey water outlet is connected to a grey water line, the valve opens (allows efflux). Thus, in case of power failure overfilling of the washing unit can be prevented.

For some types of vehicles the dishwasher system may comprise a high-power mode and at least one low-power mode, respectively may switch between working in a high-power mode and working in at least one low-power mode. The control unit of the dishwasher system may be arranged such that it allows the dishwasher system to run in a high-power mode and in at least one low-power mode.

When in the high-power mode, the dishwasher system will normally operate at its nominal power consumption (e.g. at 4 kW). Hence, all processes performed by the controller and the washing unit (including e.g. heating of fresh water, pumping and washing) can be performed, the peak power consumption not exceeding the nominal power consumption. When in a low-power mode, the dishwasher system will operate such that its power consumption does not exceed a pre-defined maximum value which is lower than the full nominal power consumption of the dishwasher system. Hence, when in a low-power mode, certain power consuming processes of the dishwasher will be disabled or will not be allowed to run at the same time as certain other processes.

Certain types of aircraft comprise electrical power management systems that enforce a prioritization among electric consumers when the power capacity is not sufficient to operate all consumers at the same time. Typically, galley ovens will be regarded as high priority consumers, whereas other devices such as dishwashers will typically be regarded as low priority consumers. Consequently, in order to prevent overloading of the electrical system, such electrical power management systems will force at least some low priority consumers to turn off, respectively cut-off electrical power supply, when a high priority consumer is to be turned on. If a dishwasher system is provided with a safety valve arrangement for power failure as described above, cut-off of electrical power will lead to efflux of all heated fresh water and heated washing liquid present in the dishwasher system. This leads to an increase of water consumption as well as total power consumption of the dishwasher system. Therefore a dishwasher system may be provided with a first low-power mode, in which the dishwasher system will essentially be turned off, but with a first (inlet) valve arranged at the fresh water inlet and a second (outlet) valve arranged at the grey water outlet both being in a closed state, restricting influx of fresh water and efflux of washing liquid present in the dishwasher system. Hence, while being in this first low-power mode, efflux of liquids is prevented while power consumption of the dishwasher system is reduced to a first predefined maximum value (e.g. 100 W) which is significantly lower than the nominal power consumption (e.g. 4 kW). Hence most processes will be disabled. When in the first low-power mode, a control unit may control closure of the first and the second valve, may indicate to a user that the dishwasher system is in a low-power mode as well as it may save the status (e.g. stage in a washing cycle) of the dishwasher system before it switched to the first power saving mode. The first (inlet) and the second (outlet) valve may e.g. be solenoid valves, the first valve being open when an electric current is applied to it and the second valve being closed when current voltage (respectively a signal) is applied to it. As such types of valves are modest power consumers, total power consumption of the dishwasher system when in the first low-power mode can be very low and hence will not interfere with operation of e.g. a galley oven.

Alternatively or in addition, the dishwasher system may comprise a second low-power mode in which certain modest power consuming processes (e.g. economized rinsing, illumination of the washing chamber for loading, programming of the next washing cycle) are allowed, the total power consumption being less than a second predefined maximum value (e.g. 500 W) which is significantly lower than the nominal power consumption (e.g. 4 kW). Hence, after being switched to the second low-power mode, the dishwasher system may e.g. finish an already running washing cycle in a normal manner, but not perform any high-power processes (as e.g. heating new fresh water). Alternatively, after being switched to the second low-power mode, an already running washing cycle may be continued (or a new washing cycle may be started) in a modified (power-saving) way, such as using washing liquids at lower temperature and/or omitting certain steps of the washing cycle and/or prolonging certain steps of the washing cycle.

Good results may be obtained if the dishwasher system comprises a control unit which is arranged such that when the dishwasher system is switched from a low-power mode to the high-power mode, the mode of operation of the dishwasher system is at least temporarily modified based on the status the dishwasher system had before being switched to the low-power mode and/or the status the dishwasher system had before being switched to the high-power mode. This modification of the mode of operation may also base on the duration it had been in the low-power mode. Hence, e.g. washing cycles interrupted or altered during a low-power mode may be restarted or continued in altered manner in order to obtain best dishwashing results.

The electrical power consumed by the dishwasher system when in a low-power mode may be provided by the same electrical system as when in the high-power mode. Alternatively or in addition, it may be provided by an auxiliary electrical power system (such as a low-voltage system or a battery), which may e.g. be used if an electric power management system completely cuts the main electric power supply off. Hence, the dishwasher system may e.g. comprise a high-power electrical interface that provides power for the power-consuming processes (such as heating) when in the high-power mode and a low-power electrical interface that provides power for maintaining certain minimum processes when in a low-power mode.

In order to switch from the high-power mode to a low-power mode (and vice versa), the dishwasher system may receive a control signal from an electrical power management system or (directly or indirectly) from a high priority consumer of an aircraft. The control signal may comprise a predefined maximum value of power allowed to be consumed by the dishwasher system (e.g. 100 W). This value may serve to determine to which type of low-power mode the dishwasher system has to switch in order to restrict power consumption to this maximum value and/or to determine what types of processes are allowable when being in the low-power mode. Good results may be obtained if the dishwasher system is provided with polyphase electric power and at least one phase is used in order to trigger switching between high-power and low-power modes. E.g. when using three-phase electric power supply, a first phase may be used to power a control unit, whereby a second and a third phase are used to power the main power consumers (e.g. a boiler) of a dishwasher system. By means of a switch (automated or manipulated by a human operator) the second and third phases may be cut-off in order to provide more power to a high priority consumer. The control unit will be still powered by the first phase and detect cut-off of the second and third phase, and identify this as signal to switch to a low-power mode, hence e.g. keep a first (inlet) valve and a second (outlet) valve closed. In case of a complete power failure (e.g. due to an emergency case), the first phase will be de-energized as well, leading to opening of the second (outlet) valve.

Alternatively or in addition switching between the different operating modes may be triggered by current and/or voltage and/or any type of signal provided to the dishwasher system.

Cabin safety may be increased if the dishwasher system comprises a control unit configured to detect an emergency case (e.g. total power failure of the galley) and switch the dishwasher system to an emergency mode. In an emergency mode all liquids present in the dishwasher system may be exhausted to the aircraft's grey water system and/or to any alternate drain system and/or the dishwasher system may be completely shut down and/or the door may be closed and/or be locked.

The concept of a dishwasher system comprising a high-power mode and at least one low-power mode as described above can be considered to be an independent inventive concept, independent of the dishwasher system as described herein.

For some applications the counterpart may be arranged stationary. Hence the counterpart may be arranged fixed on the floor or at a sidewall of a galley of e.g. an aircraft where the dishwasher system is intended to be installed. The quick coupling and counterpart may be arranged such that connection between the two of them is automatically established as soon as the washing unit is put in place. The counterpart may be part of a base plate on which the washing unit can be mounted and which may be mechanically interconnected with the floor of a vehicle and whereto the washing unit can be fastened. Such an embodiment of a dishwasher system may allow fast, easy and reliable installation of a washing unit in an aircraft cabin and hence e.g. easy modification of a galley, depending on current needs. In a variation of the invention, a base plate may comprise a drip pan arranged to collect liquids leaking from the outer housing of the washing unit. The drip pan is preferably made form a light weight material such as fiber composite material.

Good cabin safety may be obtained if the washing unit and/or a base plate comprise/comprises a drip pan which comprises a fluid sensor arranged to effect cut of fluid flow to the washing unit in case fluid enters the drip pan. Such a fluid sensor may also be arranged in a drip pan arranged in the outer housing of a washing unit.

In a variation of the invention the dishwasher system comprises a drainage which is interconnected to a heat exchanger arranged in the outer housing. Alternatively or in addition, a dishwasher system may comprise a heat exchanger arranged outside of the outer housing.

In order to facilitate refilling of detergents and (if present) other chemical agents, at least one tank for detergents (and/or other chemical agents) may be arranged inside of the washing chamber. Alternatively or in addition, at least one such tank may be arranged under the washing chamber but accessible via the washing chamber. Thus corrosion, respectively damage, of the dishwasher and surrounding interior fittings due to spilling of detergents or other substances while refilling can be prevented.

According to one variation of the invention a dishwasher system may comprise a reservoir for fresh water which is arranged inside the outer housing. Thus a relatively large amount of water may be provided within short time, making short washing cycles possible. A reservoir may comprise detergents.

Alternatively or in addition, a dishwasher system may comprise a reservoir for fresh water which is arranged outside of the outer housing, as will be shown in further detail below. Thus, a particularly lightweight and/or small washing unit may be obtained. A reservoir for fresh water may be arranged to contain hot and/or cold water. The reservoir for fresh water may e.g. be arranged underfloor at a certain distance from the washing unit. Hence, when installed in an aircraft, a reservoir may also be arranged underfloor in the cargo compartment, whereas the washing unit may be installed in the passenger compartment. However, in a variation of the invention, the reservoir may also be arranged above the washing unit.

The reservoir may be thermally insulated. Thus, energy consumption of the dishwasher may be decreased significantly. The reservoir may comprise a heating element to heat the content of the reservoir. In such a variation of the invention, the reservoir may act as a boiler. In order to reduce duration of the washing cycles, decrease energy consumption, as well as to reduce thermal stressing of e.g. an aircraft's grey water system the reservoir may be interconnected to a heat exchanger such thermal energy is transferred from waste water (grey water) to fresh water. Alternatively or in addition, in order to improve heating capability and/or decrease electrical power consumption, a dishwasher system may comprise a heat exchanger which is thermically interconnected with the bleed air system of the aircraft, arranged to transfer thermal energy from the bleed air to the fresh water, if desired. Alternatively or in addition, the dishwasher system may also be configured such that the heating element to heat the content of the reservoir is turned off before certain other main power consumers of the dishwasher are turned on. Main power consumers may e.g. be water pumps, auxiliary heating elements, condensers etc. Thus, peak power consumption during washing cycles can significantly be reduced if compared to traditional dishwasher systems. A reduction of peak power consumption also allows to decrease electromagnetic interference (EMI).

The washing chamber may comprise at least two movable washing arms arranged horizontally behind each other. The movable washing arms may e.g. rotate around an axis or may move in a translational manner do a combination of translational and rotational movements. Thus nozzles arranged at the washing arms may change position and/or orientation within the washing chamber over time in order to improve the cleaning process. Due to the application of multiple washing arms, good washing results can be obtained even if the washing chamber has a slender shape. Compared to conventional dishwasher systems, the washing arms may be relatively short. A dishwasher system according to the invention may comprise fixed nozzles. Alternatively or in addition, the washing chamber may comprise at least two movable washing arms arranged vertically on different levels. It turned out that in particular for washing chambers with a slender shape, for many types of dishware and glasses particularly good washing results can be obtained with such an arrangement of the washing arms.

Alternatively or in addition, in order to prevent staining of the frontal surface of the washing unit and/or surrounding interior fittings, the dishwasher system may comprise means to generate an essentially horizontal airflow (airstream) that extends along the width and above of the door, forming an air curtain. Therefore the washing chamber may e.g. comprise an air outlet surrounding the front opening at least partially. Thus direct contact between the frontal surfaces and the humid air, which may escape the washing chamber as soon as the door is opened, can be prevented. In a variation of this aspect of the invention, the essentially horizontal airflow may be generated as soon as the door is opened or may at least be increased in intensity as soon as the door is opened.

Good results may be obtained if the temperature of the airflow is higher than the air temperature of the galley. The airstream may at least be partially generated by the control unit of the dishwasher. Good results may be obtained, if the airflow comprises cooling air taken from the control unit.

In order to reduce undesired staining of the front surface of the dishwasher, as well as to improve cooling of the control unit and hence be able to increase power/capacity of the dishwasher system, the control unit may be arranged at a certain distance on top of the washing unit, such that a gap between the two units can be used to generate an airflow as described above. Alternatively or in addition, the dishwasher system may comprise an inlet of a suction device which is surrounding the front opening at least partially for extraction of water vapor.

Alternatively or in addition, the washing chamber of the washing unit may be fluidically interconnected with an exhaust vent installation (e.g. the exhaust vent installation of an aircraft, which may be used for lavatories) such that the air pressure within the washing chamber may be at least temporarily reduced if compared to the air pressure outside of the washing chamber. Thus undesired emission of dishwashing odor and/or humidity into the galley—respectively passenger compartment—and resulting olfactory contamination and/or corrosion may be reduced. A Alternatively or in addition, the washing unit may comprise at least one condenser in order to cool and/or dry the air in the washing chamber.

Alternatively or in addition insulating material may be arranged between the inner housing and the outer housing. Using thermal insulating material may help in maintaining constant high temperatures during the dishwashing process, as well as in preventing surrounding interior fittings from thermal damage as well as users from thermal injuries when touching outer surfaces of the washing unit. Sound insulating material may be used in order to improve soundproofing of the washing machine. Thermal and sound insulation may also be combined.

The control unit and/or fluidic components (heating element, heat exchanger, reservoir etc.) may be arranged separated from and outside of the outer housing of the washing unit. Thus the washing unit may be designed (respectively dimensioned) relatively independently from the control unit and/or at least some of the fluidic components of the dishwasher system. This provides more freedom in design of the washing unit and thus also allows reducing the outer dimensions of the housing of the washing unit. Thus, such a variation of a dishwasher system may also be used in e.g. aircraft with relatively small bodies. In addition, removing at least one of these components from the washing unit's outer housing allows to spatially distribute the weight of the components usually present in a dishwasher, as will be explained in further detail below. Another advantage of such a modular system is that e.g. the individual units may easily be replaced or removed from the aircraft in case of being defect, decreasing time and costs necessary for inspection and/or maintenance. Hence, extended grounding of an aircraft can be avoided.

One or multiple fluidic components may be arranged in a fluid providing unit. A reliable and maintenance-friendly dishwasher with a lightweight washing unit may be obtained if the fluid providing unit comprises at least one reservoir for fresh water which may comprise at least one heating element (hence be a water boiler) and/or one water pump and/or a filter for filtering fresh and/or grey water and/or a fluid pressure sensor and/or a fluid flow sensor and/or a fluid temperature sensor. Thus, the number of fluidrelated components located in the washing unit may be minimized, allowing to reduce the total weight as well as the outer dimensions of the washing unit. Alternatively or in addition this allows to increase the inner volume of the washing chamber. As well, by this the amount of maintenance necessary for the washing unit can be decreased.

A versatile dishwasher may be obtained if the control unit and/or a fluid providing unit may be arranged spatially separated from the washing unit by a certain distance. Thus, whereas the washing unit may be arranged at an easily accessible location of a galley of an aircraft, the control unit and the fluidic components unit may be arranged at different locations, as they do not have to be accessed by a user during normal usage. As such, the fluid providing unit and/or the control unit may be arranged underfloor in the cargo compartment of an aircraft, whereas the washing unit may be arranged in the galley of the aircraft, as will be explained in further detail below.

In order to increase user (and vehicle) safety, the dishwasher system may comprise a residual-current device. Such a residual-current device may be arranged at the control unit but may also be arranged separated from it. According to an aspect of the invention, an adapter cable for a dishwasher system is provided, which adapter cable comprises a residual-current device, the adapter cable being configured to electrically interconnect the dishwasher system with an electrical power supplier. Good results may be obtained if the residual-current device is arranged in a housing to which at least one first cable (configured to be connected with an electrical power supplier) and a second electrical cable (configured to be connected with the dishwasher system) are connected. Thus, the residual current device may be installed in a certain distance from the dishwasher system, which is advantageous if the installation space for the dishwasher system is limited. The housing of the residual-current device may comprise fastening points which allows it to be fastened e.g. to interior fittings.

A control unit may comprise means for electronic and/or electromechanical control of the operation of the dishwasher, but may also comprise a power supply unit which may provide the washing unit and/or a fluid providing unit (if present) with electrical power. A control unit may comprise a user control interface, such as a control panel which allows a user to control the operation of the dishwasher. However, alternatively or in addition, a user control interface may also be arranged at the washing unit and/or at another location accessible by a user. The user control interface of the dishwasher may also be a central user control interface which can be used to control multiple different devices of a galley. Thus, peak power consumption of a galley that comprises multiple electrical consumers may be controlled, respectively limited.

Easy maintenance and repair of the control unit may be obtained if the control unit comprises at least one line replaceable unit (LRU) or is a line replaceable unit.

In order to allow easy access for maintenance, a wall of the outer housing may be arranged removable.

For some applications, the washing unit may be mounted on rollers, which allow it to be rolled on the floor of the aircraft, when not being mechanically fastened to the aircraft (respectively a galley or other interior fitting). Thus, the washing unit may be easily brought into and removed from an aircraft, e.g. in order to implement temporal changes in the configuration of a galley. In order to allow easy installation and removal of the washing unit, the outer housing may comprise at least one hoisting point by which the washing unit can be hoisted. A hoisting point may comprise a handle.

According to another aspect of the invention, the (front) door may be at least partially transparent such that at least a portion of the washing chamber can be viewed from outside even when the door is closed. Thus, the door may e.g. comprise a window. An illumination may be present to illuminate the inside of the washing chamber. Thus visual monitoring of the washing cycle becomes possible. Good results may be obtained if the illumination is arranged inside the washing chamber. However, the invention is not limited to such a positioning of the illumination and the illumination may e.g. also be arranged at least partially in the front door, in particular in a transparent portion of the front door. For some applications, the illumination may be arranged to emit light of different colors. In one variation according of this aspect of the invention, the color of the light emitted may indicate the status of the dishwasher. As such, e.g. washing activity and/or standby may be indicated. Illumination may also indicate if the items in the washing chamber are dirty or are clean. Thus the end of a washing cycle may be clearly indicated without the need of e.g. an acoustic signal which may not be heard in a noisy environment (e.g. in an aircraft) or may be undesirable. Alternatively or in addition, such indication may also be obtained by the mere presence—respectively absence—of illumination, or flashing or diming. It will be appreciated that an at least partially transparent door with an illumination as described above is an independent inventive concept which us usable for dishwashers in general and thus not limited to a dishwasher system as described herein. Hence, it may also be used for e.g. domestic dishwashers.

A dishwasher that can be used for a large group of aircraft can be obtained if the washing unit has a total outer height of between 950 mm and 1050 mm and a total depth of between 700 mm and 800 mm and a width of between 250 mm and 650 mm. Such embodiments of a washing unit may be installed in standard galley stowage compartments.

In order to obtain a particularly highly versatile and easy-to-install dishwasher system, the washing unit may have an outer height of 1000 mm, an outer depth of 700 mm and an outer width of 300 mm. Hence, such an embodiment of a washing may be installed in a galley instead of a single service trolley.

Good results may be obtained, if the total maximum weight of a washing unit loaded with a rack and items to be cleaned is equal or less than the total maximum weight of a service trolley. Thus no additional reinforcements of the galley storage compartments, respectively the floor, are necessary. Such relatively lightweight washing units become possible with a modular dishwasher according to the invention, as has been explained above.

In order to apply the dishwasher system to a group of aircraft with galley compartments according to another standard, also washing units with different outer dimensions may be used. As such, e.g. the washing unit may have a total outer height of between 950 mm and 1050 mm and a total depth of about 400 mm and a outer width of between 250 mm and 650 mm, preferably 300 mm or 600 mm, thus have about the outer dimensions of a standard half-size airline service trolleys (for 300 mm width), respectively two standard half-size airline trolley arranged side-by-side (for 600 mm width). It is one advantage of the present invention that a large variety of washing units with outer dimensions different from one another may be easily obtained, as has been explained above. However, the present invention is not limited to washing units which having the above-mentioned dimensions and hence a washing unit may e.g. also have a width of e.g. 450 mm. A dishwasher system which has a relatively large washing chamber but may still be installed in a relatively large group of vehicles may be obtained if the outer housing has a total height of 800 mm, a total width of 600 mm and a total depth of 600 mm.

In accordance with an aspect of the present invention, an installation arrangement for a dishwasher system is provided, where the washing unit is located in a passenger compartment of a vehicle (e.g. an aircraft), whereas a fluid providing unit is located in the cargo compartment. Hence a fluid providing unit comprising a reservoir for water and/or a water pump and/or a heating element and/or a heat exchanger is/are located in a cargo compartment of the vehicle. Good results may be obtained, if the fluid providing unit is arranged underfloor between the floor beams of an aircraft, in particular close and below the washing unit.

For some applications—alternatively or in addition—a fluid providing unit and/or the control unit may be arranged in the same housing or in multiple housings which has/have specified outer dimensions according to standards for service trolleys as described with respect to the washing unit above. Hence, in a variation of the present invention, one or multiple components of a dishwasher system may be arranged in e.g. service trolley-sized housings—that may be arranged on rollers—and be arranged in multiple standard stowage compartments of a galley. Housings with different dimensions are possible. Easy installation of such dishwasher systems may be obtained if the washing unit and/or a control unit and/or a fluid providing unit are arranged side-by-side or back-to-back in one or multiple stowage compartments.

A fluid providing unit and the washing unit will typically be fluidically interconnected by means of one fluid line or multiple fluid lines. Also other types of interconnections may be present, such as electrical connections. The fluid providing unit may provide washing fluid—in particular hot and/or cold water to the washing unit. For some applications, the fluid providing unit may also provide hot air and/or steam to the washing unit. Thus cleaning and/or sanitizing and/or deodorization of e.g. the dishware as well as of the washing chamber itself may be obtained, if desired.

Good results may be obtained if the washing unit and the fluid providing unit are fluidically interconnected by means of large diameter tubes or hoses (fluid lines) in order to obtain high volume rate flows at low pressure gradients. To maintain fluid temperature in the fluid lines, the fluid lines may comprise means for thermal insulation.

In order to increase cabin safety, fluid lines may be configured such that the maximum fluidic volume rate of inflow into the washing unit is lower than the maximum volume rate of outflow from the washing unit. Thus overflow of the washing chamber and/or a drip pan (if present) can be avoided. Therefore the inner cross-sectional area of the fluid lines for inflow may e.g. be significantly lower than the inner cross-sectional area of the fluid lines for outflow.

The fluid providing unit may comprise at least one fluid receiving means which is fluidically interconnected with the washing unit. Such a fluid receiving means may be arranged to receive grey water and/or air and/or steam and/or wet steam from the washing unit. For some applications, the fluid providing unit may comprise at least one tank for fresh and/or grey water. Thus—if desired—such a variation of a dishwasher may be at least temporarily operated independently from the fresh and grey water system of an aircraft. For some applications, the fluid providing unit may comprise at least one filter means to filter fluids before providing them to the washing unit and/or the grey water system of the aircraft. Hence clogging of the grey water system (which may comprise a grey water drain mast and/or a tank) can be prevented. In addition, a fluid providing unit may comprise means for chemical treatment of the grey water. Such means may be arranged to neutralize detergents present in the grey water before they enter the grey water system of the aircraft.

A fluid providing system for a dishwasher system according to the invention may also be used to provide hot and/or cold water to other consumers, such as to a sink, to a shower or to a washing machine.

Another aspect of the invention is directed to a galley assembly for a flight vehicle comprising a dishwasher system as described herein.

Another aspect of the present invention relates to a washing unit for a dishwasher system which comprises a tank for washing liquids, whereby the tank comprises a separation element which is partitioning the inner volume of the tank. Thus sloshing effects inside of the tank can be prevented. It will be appreciated that a washing unit with a tank having a separation element can also be considered to be an independent inventive concept, independent of the aforementioned dishwasher system. However, in combination with a dishwasher system according to the present invention, very efficient sloshing prevention becomes possible as the geometry of the tank and the separation element can be optimized for sloshing prevention and can be chosen independently from the boiler and/or pump geometry, which both in traditional dishwasher systems influence the geometry of the tank.

Very efficient sloshing protection may be obtained if the separation element comprises at least one baffle plate. Alternatively or in addition, the separation element may comprise at least one tube/rod. Good reduction of sloshing may be obtained, if the baffle plate and/or tube/rod is/are installed/aligned essentially in vertical direction. However, in particular for aircraft, at least some separation elements may be aligned in horizontal direction. As such, a horizontal baffle plate may be arranged at the bottom of a washing chamber in order to filter grey water and to prevent sloshing effects. Easy maintenance
in particular cleaning—of the washing unit becomes possible if the separation element is removable from the tank. Alternatively or in addition the washing unit may comprise multiple tanks for the washing liquids which are fluidically interconnected with each other.

A further aspect of the present invention, which may also be regarded as an independent inventive concept, relates to a rack for a dishwasher which, when being in the washing chamber, is mechanically interconnected to the washing chamber such that relative movements between washing chamber and rack are inhibited. Good results may be obtained if the rack comprises protrusions that engage and mechanically interlock with corresponding receptors (e.g. slots) arranged in the washing chamber of the washing unit.

One aspect of the invention is directed to a retention system for dishware, glasses and/or cutlery in a dishwasher suited to be used in aircraft, wherein the retention system comprises an elastic net interconnected with the rack and/or the washing unit and which fastens the items to be cleaned to the rack, as will be explained in further detail below. Such a retention system is advantageous when used for a dishwasher system according to the present invention, but also represents an independent inventive concept that can be advantageous regardless of the type of dishwasher that is used. Alternatively or in addition, a retention system may comprise a clamping mechanism that is arranged to mechanically interconnect the dishware and other items with the rack.

### BRIEF DESCRIPTION OF THE DRAWINGS

The herein described invention will be more fully understood from the detailed description of the given herein below and the accompanying drawings, which should not be considered as limiting to the invention described in the appended claims.

FIG. 1 schematically shows a dishwasher system in an aircraft in a frontal view;

FIG. 2 schematically shows a first variation of a dishwasher system installed in the galley of an aircraft in a frontal view;

FIG. 3 schematically shows a second variation of a dishwasher system installed in the galley of an aircraft in a frontal view;

FIG. 4 schematically shows a first variation of a washing unit for a dishwasher system in a perspective view;

FIG. 5 schematically shows a rack for a dishwasher system in a perspective view;

FIG. 6 shows a variation of a washing unit for dishwasher system, partially clipped for illustrative purposes, in a perspective view;

FIG. 7 shows another variation of a dishwasher system, partially clipped for illustrative purposes, in a perspective view;

FIG. 8 shows another variation of a washing unit of a dishwasher system in a perspective view;

FIG. 9 shows detail A of FIG. 8;

FIG. 10 shows another variation of a washing unit in a frontal view;

FIG. 11 shows cross section BB of FIG. 11;

FIG. 12 shows the variation of a washing unit of FIG. 11 in a perspective view from below.

### BRIEF DESCRIPTION OF THE INVENTION

The foregoing summary, as well as the following detailed description of the preferred embodiments, is better understood when read in conjunction with the appended drawings. For the purpose of illustrating the invention, an embodiment that is presently preferred, in which like reference numerals represent similar parts throughout the several views of the drawings, it being understood, however, that the invention is not limited to the specific methods and instrumentalities disclosed.

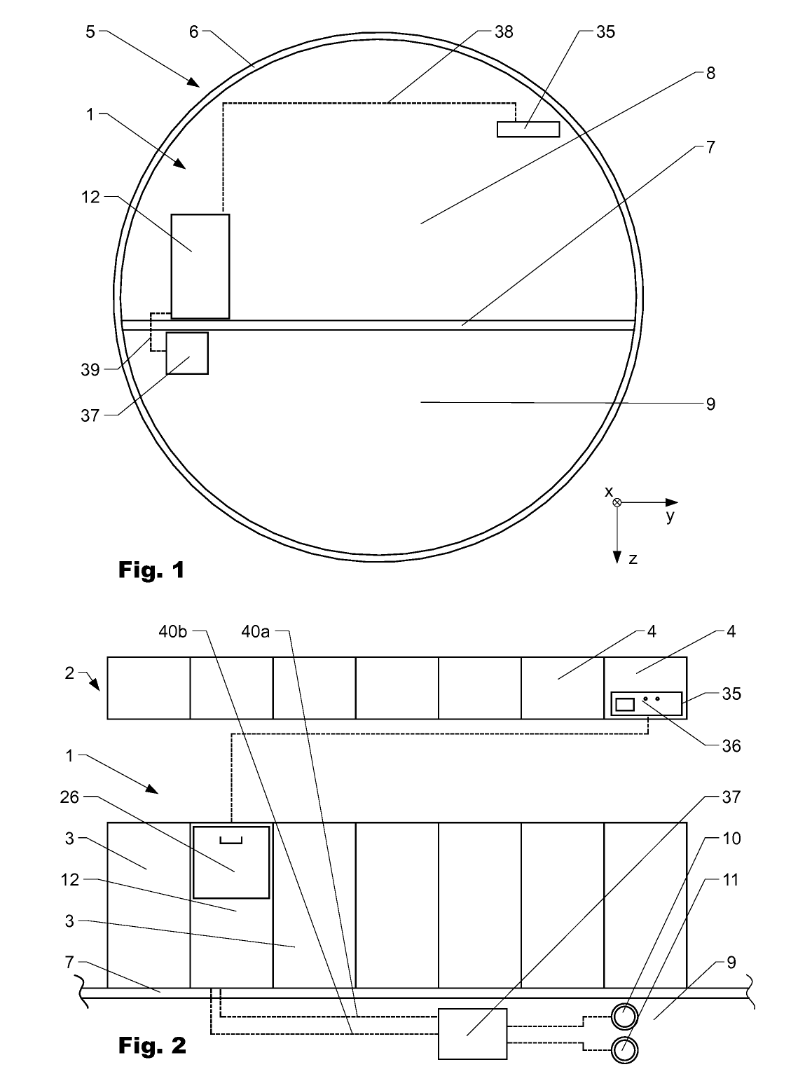

FIG. 1 schematically shows a dishwasher system 1 arranged inside of the fuselage 6 of an aircraft 5. The dishwasher system 1 comprises a washing unit 12 which is arranged in the passenger compartment 8 that is separated from the cargo compartment 9 by the floor 7. The dishwasher system 1 further comprises a control unit 35 which is also arranged in the passenger compartment 8, but separated and in a certain distance from the washing unit 12. The control unit 35 is electrically interconnected with the washing unit 12 by means of an electrical connection 38. As well, the dishwasher system 1 comprises a fluid providing unit 37 which is arranged underfloor in the cargo compartment 9 of the aircraft 1. The fluid providing unit 37 is fluidically interconnected with the washing unit 12 by means of a fluidic connection 39, which may be one or multiple hoses (not shown in detail). As well, the fluid providing unit 37 may be electrically interconnected with the washing unit 12 and/or the control unit 35 by means of electrical lines.

FIG. 2 schematically shows a variation of a dishwasher system 1 installed in a galley 2 of an aircraft (not shown). The washing unit 12 of this dishwasher system 1 is arranged instead of a lower cabinet 3 and comprises an outer housing 13 with a door 26 which can be opened to insert or remove items to be cleaned (not shown). As shown, the washing unit 12 is interconnected with a control unit 35 that is located in an upper cabinet 4 at a certain distance from the washing unit 12. The control unit 35 also comprises a user interface 36 which allows a user to control operation of the dishwasher system 1. Under the floor 7, in the cargo compartment 9, a fluid providing unit 37 is arranged. The fluid providing unit 37 comprises a first water pump as well as a water boiler (not shown) in order to provide the washing unit 12 by means of a fresh water line 40a with heated water. Fresh water is taken from the fresh water system 10 of the aircraft. As well, the fluid providing unit 37 comprises a second water pump (not shown) which is fluidically interconnected by means of a grey water line 40b with the washing unit 12 as well as with the aircraft's grey water system 11 in order to remove polluted washing fluid from the washing unit 12. Washing fluid removed from the washing unit 12 may be filtered and/or heated before being provided to the washing unit 12. Alternatively at least part of it may be dumped to the grey water system 11. Although not shown explicitly, the control unit 35 may be interconnected with the fluid providing unit 37, e.g. by an electrical line providing power and/or control signals.

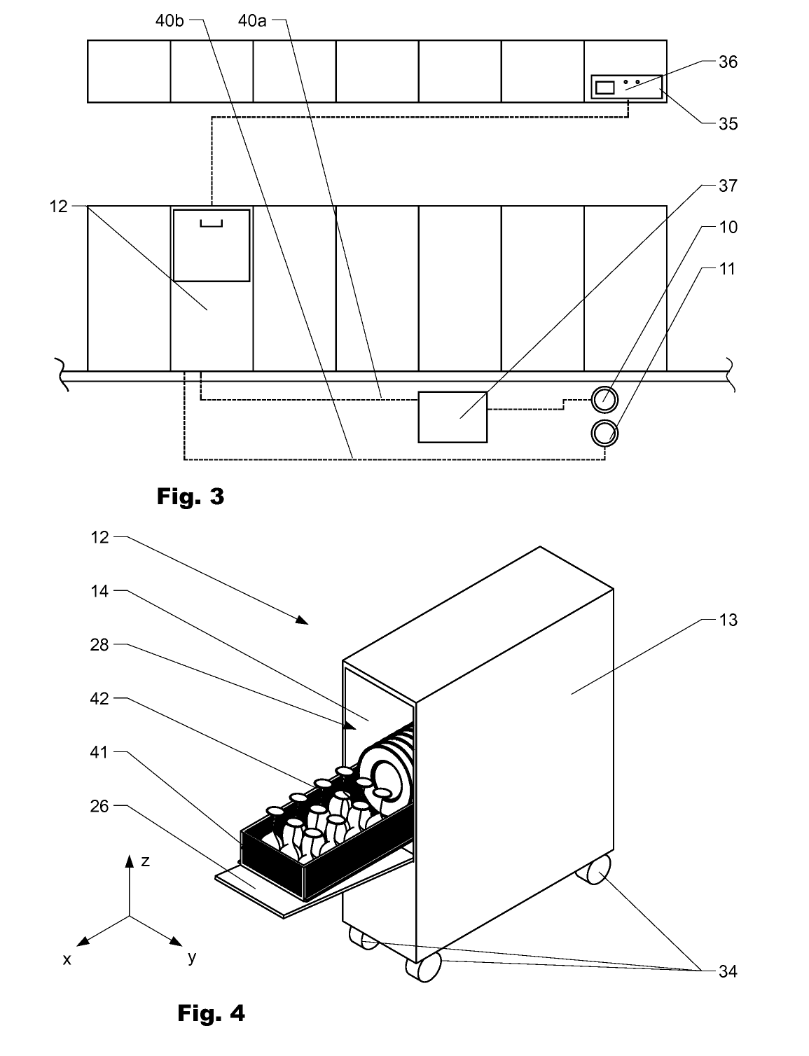

FIG. 3 schematically shows another variation of a dishwasher system 1, where grey water from the washing unit 12 is directly pumped to the grey water system 11 of the aircraft. Although not shown explicitly, the control unit 35 may be interconnected with the fluid providing unit 37, e.g. by an electrical line providing power and/or control signals.

FIG. 4 schematically shows a variation of a washing unit 12 with a rack 41 containing several glasses and dishes 42 to be cleaned in a washing chamber 28. The washing unit 12 comprises an outer housing 13 in which a door 26 is arranged. As well, it comprises an inner housing 14 which encloses the washing chamber 28. The rack 41 can be slid in and out. In order to be able to bring the washing unit 12 into—respectively remove it from—the cabin of an aircraft, the washing unit 12 comprises several rollers 34 which allow it to be rolled on the floor of the aircraft. As well, the outer dimensions of the washing unit 12 shown in FIG. 4 are essentially equal to the outer dimensions of a standardized airline service trolley. Thus, the variation of a washing unit 12 shown in FIG. 4 may be installed in a standard galley stowage compartment which otherwise foreseen to receive a service trolley.

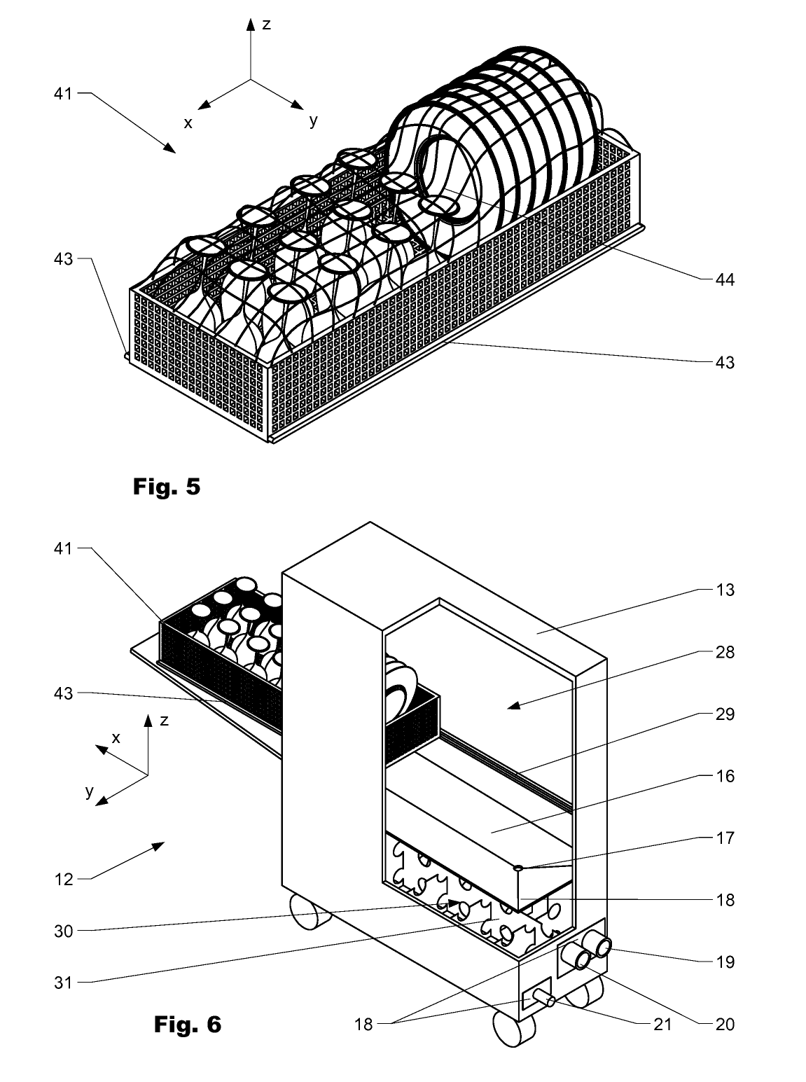

FIG. 5 schematically shows a variation of a rack 41 for a dishwasher system according to the invention. The rack 41 comprises lateral protrusions 43 which are arranged to interact with corresponding receptors of a washing unit, as will be shown in FIG. 6. As indicated in FIG. 5, the rack 41 may comprise a retention system 44 for the items 42 that are stored in it. In the variation shown, the retention system 44 is an elastic net that prevents the glasses and plates from moving if the aircraft is accelerated e.g. during takeoff or landing.

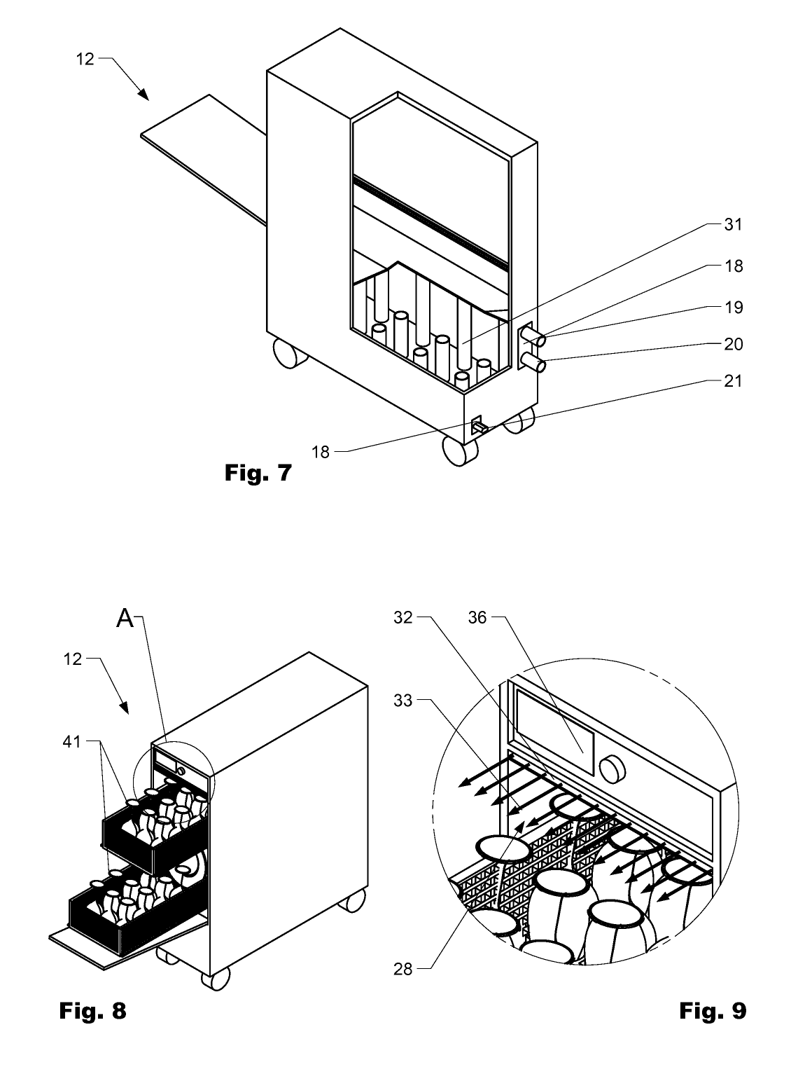

FIG. 6 schematically shows a washing unit 12 with a rack 41, the outer housing 13 of the washing unit 12 being partially clipped in order to reveal the washing chamber 28 as well as a wash fluid tank 30 arranged under the washing chamber 28. As shown, rack rails 29 are arranged in the washing chamber 28. These rack rails 29 have an essentially u-shaped cross section which is arranged to serve as a receptor for the lateral protrusions 43 of the rack 41. When the rack 41 is inserted in the washing chamber 28, the lateral protrusions 43 can move in the rack rails 29 in a sliding manner. At the same time, this sliding mechanism prevents the rack from relative movements with respect to the washing unit 12 in any direction other than the direction of this sliding movement. As also shown in FIG. 6, the wash fluid tank 30 may comprise a separation element 31, which in this variation of the invention comprises several baffle plates that are aligned in vertical direction and prevent liquids present in the wash fluid tank 30 from sloshing. In another variation of the invention, a separation element may comprise tubular elements 31, as indicated in FIG. 7.

As also indicated in FIG. 6 and FIG. 7, a washing unit 12 may comprise multiple interfaces arranged at docking panels 18 in order to interconnect it with other components or units. As shown, such interfaces may include fluid inlets and outlets 19, 20. As well, electrical interfaces 21 may be present for e.g. power supply or to transmit sensor and/or control signals to and/or from the washing unit 12. As indicated in FIG. 6 and FIG. 7, good results may be obtained if such interfaces 19, 20, 21 are arranged at the backside of the washing unit 12.

FIG. 8 schematically shows a variation of a washing unit 12 which is arranged to receive two racks 41. At the frontal face of the washing unit 12 a control comprises a controt panel 36 that serves as a user interface is arranged. Between the control panel 36 and the opening of the washing chamber 28, a slit-like air outlet 32 that extends along the whole with of the door opening is arranged. As soon as the door 26 is opened, an airflow is generated and released from the air outlet 32, forming an air curtain 33 that prevents the warm and wet air escaping from the washing chamber 28 from touching the frontal surface of the washing unit 12 and the galley. Thus condensation of water on these surfaces can be avoided. In the variation of a washing unit 12 shown in FIG. 8 and FIG. 9, the airflow used to generate the air curtain 33 comprises cooling air taken from the control unit, which in this variation is also arranged in the outer housing 13 of the washing unit 12.

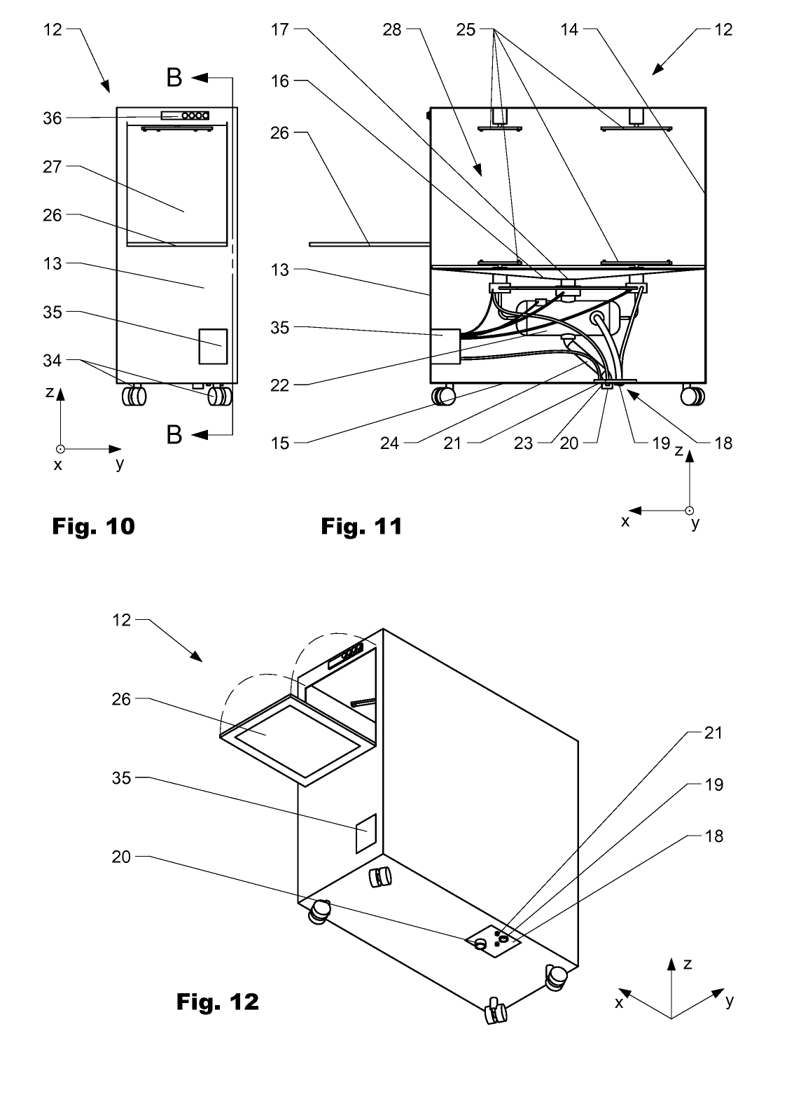

FIGS. 10 to 12 show another variation of a washing unit 12 of a dishwasher system 1 according to the invention. The washing unit 12 has a width (y-direction) of about 450 mm. A control unit 35 is arranged at the frontal side of the lower part of the washing unit's 12 outer housing. Thus it can easily be accessed from outside. As well, the washing unit 12 comprises a user interface arranged above the door 26, respectively above the front opening 27. As shown in FIG. 11, the washing chamber 28 is arranged in the upper half of the outer housing 13 and is enclosed by the inner housing 14. The inner housing 14 comprises a floor pan 16 with a drainage 17 that is arranged at the lowest point of the floor pan 16. In the washing chamber, a total of four movable washing arms 25 are arranged. The washing arms 25 are arranged vertically (z-direction) on two different levels, two being arranged at the top side of the washing chamber 28, while the others are arranged on the bottom side of the washing chamber 28. As well, the washing arms 25 are arranged horizontally (x-direction) behind each other. The washing unit 12 furthermore comprises a drip pan 15 that is arranged below the inner housing 14 and is arranged to receive liquids leaking from the inner housing 14 or the fluidic components arranged below the inner housing 14, as will subsequently be explained. Below the inner housing 14 a reservoir 22 is arranged in which a heating element to heat the content of the reservoir 22 is arranged. The reservoir 22 shown is thermally is insulated. The drainage 17 is fluidically interconnected with the reservoir 22 and a fluid outlet 20 arranged at a docking panel 18 that is arranged on the bottom side of the outer housing 13. Therefore a fluid line 24 with a continuously downward slope is made from tubes. Thus, grey water can easily be fully drained from the washing unit 12 if needed. At the docking panel 18 an exhaust valve 23 is arranged and configured to open, respectively close, the fluid line 24. The panel 18 furthermore comprises a fluid inlet 19 to receive fresh water as well as an electrical interface. All fluidic and electrical interfaces 18, 19, 20 comprise quick couplings (not shown in detail) what are arranged to interact to counterparts arranged on the floor at the location the washing unit 12 is intended to be installed. As schematically shown in FIG. 12, the door 26 of this variation of the invention comprises a transparent window.

The docking panel 18 may also be arranged close to the frontal surface of the washing unit 12 in order to be accessible for manipulation and/or visual inspection.

REFERENCE NUMERALS

| | |
|---|---|
| 1 | Dishwasher system |
| 2 | Galley |
| 3 | Lower cabinet |
| 4 | Upper cabinet |
| 5 | Aircraft (vehicle) |
| 6 | Fuselage |
| 7 | Floor |
| 8 | Passenger compartment |
| 9 | Cargo compartment |
| 10 | Aircraft fresh water system |
| 11 | Aircraft grey water system |
| 12 | Washing unit |
| 13 | Outer housing |
| 14 | Inner housing |
| 15 | Drip pan |
| 16 | Floor pan |
| 17 | Drainage |
| 18 | Docking panel (adapter plate) |
| 19 | Fluid inlet |
| 20 | Fluid outlet |
| 21 | Electrical interface (power and/or control) |
| 22 | Reservoir |
| 23 | Exhaust valve |
| 24 | Fluid line (tube, hose) |
| 25 | Washing arms |
| 26 | Door |
| 27 | Front opening |
| 28 | Washing chamber |
| 29 | Rack rail (holder) |
| 30 | Wash fluid tank |
| 31 | Separation element |
| 32 | Air outlet/inlet |
| 33 | Air curtain |
| 34 | Roller |
| 35 | Control unit |
| 36 | User interface (control panel) |
| 37 | Fluid providing unit |
| 38 | Electrical connection |
| 39 | Fluidic connection |
| 40a | Fresh water line |
| 40b | Grey water line |
| 41 | Rack |
| 42 | Items (dishware, glasses) |
| 43 | Protrusion |
| 44 | Retention system |

1. A dishwasher system comprising:
a. a washing unit with:
i. an outer housing;
ii. an inner housing enclosing a washing chamber; and
iii. a door for closing a front opening of the washing chamber; and
b. a control unit for controlling a dishwashing operation.

2. The dishwasher system according to claim 1, wherein the inner housing is arranged in an upper half of the outer housing.

3. The dishwasher system according to claim 1, wherein a drip pan is arranged below the inner housing.

4. The dishwasher system according to claim 1, wherein the inner housing comprises a floor pan with a drainage arranged at a lowest point of the floor pan.

5. The dishwasher system according to claim 4, wherein an exhaust valve is present to seal the drainage.

6. The dishwasher system according to claim 1, wherein an exhaust pump is present to exhaust the washing chamber.

7. The dishwasher system according to claim 1, wherein the washing unit comprises a docking panel arranged at the outer housing.

8. The dishwasher system according to claim 4, wherein the drainage and a docking panel are interconnected to each other by at least one continuously downward sloping fluid line such that a complete draining is possible.

9. The dishwasher system according claim 7, wherein the docking panel comprises at least one quick coupling arranged to interconnect to a counterpart.

10. The dishwasher system according to claim 9, wherein the counterpart is arranged stationary.

11. The dishwasher system according to claim 4, wherein the drainage is interconnected to a heat exchanger arranged in the outer housing.

12. The dishwasher system according to claim 1, wherein a reservoir for fresh water is arranged inside the outer housing.

13. The dishwasher system according to claim 1, wherein a reservoir for fresh water is arranged outside of the outer housing.

14. The dishwasher system according to claim 13, wherein the reservoir is arranged underfloor at a certain distance from the washing unit.

15. The dishwasher system according to claim 13, wherein the reservoir is thermally insulated.

16. The dishwasher system according to claim 13, wherein the reservoir comprises a heating element to heat the content of the reservoir.

17. The dishwasher system according to claim 11, wherein a reservoir for fresh water is interconnected to the heat exchanger such that thermal energy is transferred from waste water to fresh water.

18. The dishwasher system according to claim 1, wherein the washing chamber comprises at least two movable washing arms arranged horizontally behind each other.

19. The dishwasher system according to claim 1, wherein the washing chamber comprises at least two movable washing arms arranged vertically on different levels.

20. The dishwasher system according to claim 1, wherein insulating material is arranged between the inner housing and the outer housing.

21. The dishwasher system according to claim 1, wherein the control unit and/or a heating element and/or a reservoir are arranged outside of the outer housing and separable from the washing unit.

22. The dishwasher system according to claim 1, wherein a wall of the outer housing is arranged removable.

23. The dishwasher system according to claim 1, wherein the washing unit is mounted on rollers.

24. The dishwasher system according to claim 1, wherein the outer housing comprises at least one hoisting point by which the washing unit can be hoisted.

25. The dishwasher system according to claim 1, wherein the door is at least partially transparent such that at least a portion of the washing chamber can be viewed from outside even when the door is closed.

26. The dishwasher system according to claim 1, wherein an illumination is present to illuminate an inside of the washing chamber.

27. The dishwasher system according to claim 26, wherein the illumination is arranged inside the washing chamber.

28. The dishwasher system according to claim 26, wherein the illumination is arranged to emit light of different colors.

29. The dishwasher system according to claim 28, wherein a color of the light emitted indicates a status of the dishwasher system.

30. The dishwasher system according to claim 1, wherein the outer housing is at least partially made from a composite material.

31. The dishwasher system according to claim 1, wherein the washing unit has a total height of about 1000 mm and a total depth of about 750 mm and a width of between 600 mm and 300 mm.

32. The dishwasher system according to claim 1, wherein the washing unit is located in a passenger compartment of a vehicle, and wherein a reservoir for water is located in a cargo compartment of the vehicle.

33. The dishwasher system according to claim 32, wherein a water pump and/or a heating element and/or a heat exchanger is/are located in the cargo compartment of the vehicle.

34. The dishwasher system according to claim 1, wherein the washing unit comprises a tank for water and/or washing liquids, said tank comprising a separation element that partitions an inner volume of the tank into fluidically interconnected sub-volumes.

35. The dishwasher system according to claim 34, wherein the separation element comprises at least one baffle plate.

36. The dishwasher system according to claim 34, wherein the separation element comprises at least one tube.

37. The dishwasher system according to claim 1, further comprising a rack, wherein when arranged in the washing chamber, the rack is mechanically interconnected to the washing chamber such that relative movements between the washing chamber and the rack are inhibited.

38. A retention system for dishware and/or cutlery items in a dishwasher system, wherein the retention system comprises an elastic net interconnected with a rack and/or a washing unit and which is arranged to fasten the items to be cleaned to the rack.
